(19) United States
(12) Patent Application Publication
(10) Pub. No.: US 2018/0088364 A1
(43) Pub. Date: Mar. 29, 2018

(54) MANUFACTURE METHOD OF PSVA LIQUID CRYSTAL PANEL

(71) Applicant: Shenzhen China Star Optoelectronics Technology Co. Ltd., Shenzhen City (CN)

(72) Inventors: Rentang Zhao, Shenzhen City (CN); Chungching Hsieh, Shenzhen City (CN)

(21) Appl. No.: 15/115,689

(22) PCT Filed: Jun. 17, 2016
(86) PCT No.: PCT/CN2016/086131

§ 371 Date: Jul. 31, 2016

(30) Foreign Application Priority Data
May 13, 2016 (CN) 201610323199.0

(51) Int. Cl. G02F 1/13; G02F 1/1337; G02F 1/1341

(52) U.S. Cl. CPC G02F 1/1309; G02F 1/1341; G02F 1/133788; G02F 1/133711

(57) ABSTRACT

Disclosed is a manufacture method of a PSVA liquid crystal panel. The alignment film material of forming the alignment film comprises polyimide polymer, and a molecule of the polyimide polymer comprises a polyimide main chain and a side chain polymerizable reactive group. The alignment of the liquid crystal molecules can be achieved with one time of ultraviolet irradiation that the reactive group of the polyimide polymer side chain in the alignment film has polymerization. In comparison with the manufacture method according to prior art, the reactive monomer, which makes the liquid crystal have pre-tilted angle by the polymerization, is employed to be the side chain group directly connected to the main body material of the alignment film material to form the reactive group on the polyimide polymer but not mixed in the liquid crystal material. No free reactive monomer exists in the liquid crystal layer.

### FIELD OF THE INVENTION

The present invention relates to a display skill field, and more particularly to a manufacture method of a PSVA liquid crystal panel.

### BACKGROUND OF THE INVENTION

The Thin Film Transistor-Liquid Crystal Display (TFT-LCD) has advantages of high color degree, small volume and low power consumption, and occupies the main stream position in the present flat panel display field. For the TFT-LCD in the mainstream market, three types, which respectively are Twisted Nematic (TN), Super Twisted Nematic (STN), In-Plane Switching (IPS) and Vertical Alignment (VA) can be illustrated. The VA liquid crystal display possesses extremely high contrast than the liquid crystal displays of other types. It has very wide application in large scale display, such as television or etc.

The polymer-stabilized vertical alignment (PSVA) technology can make the liquid crystal display panel possess advantages of faster response time and high transmittance. The distinguishing feature is to form polymer protrusions on the surface of the alignment film to make the liquid crystal molecules have a pre-tilted angle.

The manufacture process of the traditional PSVA panel generally comprises steps of:

step 1, providing an upper substrate 100 and a lower substrate 200, and arranging PI (polyimide) alignment films 30 on the upper substrate 100 and the lower substrate 200;

step 2, dropping liquid crystal combination substance on the upper substrate 100 or the lower substrate 200, wherein the liquid crystal combination substance comprises liquid crystal material 410 and Reactive monomer (RM) 420 mixed in the liquid crystal material 410, and oppositely assembling the upper substrate 100 and the lower substrate 200 to form a liquid crystal layer 400 between the upper substrate 100 and the lower substrate 200 to obtain a liquid crystal cell;

step 3, as shown in FIG. 1, performing the first ultraviolet (UV) light irradiation to the liquid crystal cell, and applying a certain voltage to the upper substrate 100 and the lower substrate 200 so that the reactive monomers 420 in the liquid crystal combination substance has polymerization with the UV light irradiation to form polymer protrusions on the upper substrate 100 and the lower substrate 200 to make the liquid crystal material 410 have a pre-tilted angle, and this manufacture process is the ultraviolet light alignment;

step 4, as shown in FIG. 2, performing the second ultraviolet (UV) light irradiation to the liquid crystal cell, and because the reactive monomers 420 cannot completely react in the first ultraviolet light irradiation, and some remain in the liquid crystal material 410. For removing these reactive monomers 420, with the second ultraviolet light irradiation, the weaker UV light is employed to make the reactive monomers 420 completely react.

As shown in FIG. 3, after two times of UV light irradiation, the ultraviolet light alignment is accomplished, and no reactive monomers 420 remain in the liquid crystal layer 400. However, in the practical production, the time of the second ultraviolet light alignment is very long, which is about two hours, and thus the power consumption is high. Besides, the alignment of the liquid crystal material 410 is achieved by that the free reactive monomers 420 in the liquid crystal material 410 have reaction. In the ultraviolet light alignment, the concentration distribution of the free reactive monomers 420 and the intensity of the ultraviolet light will determine the quality of the alignment. For instance, as the distribution of the free reactive monomers 420 is non-uniform, the drop Mura issue will happen to the liquid crystal panel, i.e. the black spot defects which is regularly distributed exist in the panel, and thus the panel quality descends; moreover, as the intensity of the ultraviolet light is stronger, and the concentration of the reactive monomers 420 is higher, the implosion of the reactive monomers happens, and the broken bright spots generate as the liquid crystal panel shows images, and the panel quality is seriously influenced.

### SUMMARY OF THE INVENTION

An objective of the present invention is to provide a manufacture method of a PSVA liquid crystal panel, in which the second time ultraviolet irradiation is not required to eliminate the reactive monomers mixed in the liquid crystal layer, and meanwhile, the issues of the drop Mura, broken bright spot of the liquid crystal panel can be prevented to decrease the production cost and to raise the liquid crystal panel quality.

For realizing the aforesaid objective, the present invention provides a manufacture method of a PSVA liquid crystal panel, comprising steps of:

step 1, providing an upper substrate and a lower substrate, and coating one layer of alignment film material respectively on one sides of the upper substrate and the lower substrate to form alignment films;

the alignment film material comprising polyimide polymer, and a molecule of the polyimide polymer comprising a polyimide main chain and a side chain polymerizable reactive group;

step 2, injecting a liquid crystal combination substance including liquid crystal molecules on one side of the upper substrate or the lower substrate with the alignment film, and then making sides of the upper substrate and the lower substrate having the alignment films face with each other to oppositely assemble the upper substrate and the lower substrate to be a cell to form a liquid crystal layer between the upper substrate and the lower substrate to obtain a liquid crystal cell;

step 3, applying a certain voltage to the upper substrate and the lower substrate, and irradiating ultraviolet light to the liquid crystal cell and the reactive group of the polyimide polymer side chain in the alignment film on the opposite sides of the upper substrate and the lower substrate having polymerization under irradiation of the ultraviolet light to make the liquid crystal molecules in the liquid crystal layer have pre-tilted angle.

In the step 3, a wavelength of the ultraviolet light irradiating the liquid crystal cell is between 300 nanometer and 400 nanometer.

In the step 3, an irradiation intensity of the ultraviolet light irradiating the liquid crystal cell is between 0.08 mW/cm² and 110 mW/cm².

in the step 3, the wavelength of the ultraviolet light irradiating the liquid crystal cell is 313 nanometer, and the irradiation intensity is between 0.08 mW/cm² and 10 mW/cm².

In the step 3, a duration of the ultraviolet light irradiating the liquid crystal cell is 50 second to 600 second.

In the step 2, an one drop filling is employed to inject the liquid crystal combination substance on one side of the upper substrate or the lower substrate.

In the step 3, the pre-tilted angle of the liquid crystal layer is 88° to 89°.

The upper substrate is a color film substrate, and the lower substrate is a TFT array substrate.

The step 1 further comprises performing a pre baking process and a high temperature baking process to form the alignment films after coating one layer of alignment film material respectively on one sides of the upper substrate and the lower substrate.

The present invention further provides a manufacture method of a PSVA liquid crystal panel, comprising steps of:

step 1, providing an upper substrate and a lower substrate, and coating one layer of alignment film material respectively on one sides of the upper substrate and the lower substrate to form alignment films;

the alignment film material comprising polyimide polymer, and a molecule of the polyimide polymer comprising a polyimide main chain and a side chain polymerizable reactive group;

step 2, injecting a liquid crystal combination substance including liquid crystal molecules on one side of the upper substrate or the lower substrate with the alignment film, and then making sides of the upper substrate and the lower substrate having the alignment films face with each other to oppositely assemble the upper substrate and the lower substrate to be a cell to form a liquid crystal layer between the upper substrate and the lower substrate to obtain a liquid crystal cell;

step 3, applying a certain voltage to the upper substrate and the lower substrate, and irradiating ultraviolet light to the liquid crystal cell and the reactive group of the polyimide polymer side chain in the alignment film on the opposite sides of the upper substrate and the lower substrate having polymerization under irradiation of the ultraviolet light to make the liquid crystal molecules in the liquid crystal layer have pre-tilted angle;

wherein in the step 2, an one drop filling is employed to inject the liquid crystal combination substance on one side of the upper substrate or the lower substrate;

wherein in the step 3, the pre-tilted angle of the liquid crystal layer is 88° to 89°;

wherein the upper substrate is a color film substrate, and the lower substrate is a TFT array substrate.

The benefits of the present invention are: the present invention provides a manufacture method of a PSVA liquid crystal panel. The alignment film material of forming the alignment film comprises polyimide polymer, and a molecule of the polyimide polymer comprises a polyimide main chain and a side chain polymerizable reactive group. The alignment of the liquid crystal molecules can be achieved with one time of ultraviolet irradiation that the reactive group of the polyimide polymer side chain in the alignment film has polymerization. In comparison with the manufacture method of the PSVA liquid crystal panel according to prior art, the reactive monomer, which makes the liquid crystal have pre-tilted angle by the polymerization, is employed to be the side chain group directly connected to the main body material of the alignment film material to form the reactive group on the polyimide polymer but not mixed in the liquid crystal material. No free reactive monomer exists in the liquid crystal layer. Thus, it is not required to perform the second time ultraviolet irradiation to eliminate the reactive monomers mixed in the liquid crystal layer, and meanwhile, the issues of the drop Mura, broken bright spot of the liquid crystal panel can be prevented to decrease the production cost and to raise the liquid crystal panel quality.

### BRIEF DESCRIPTION OF THE DRAWINGS

In order to better understand the characteristics and technical aspect of the invention, please refer to the following detailed description of the present invention is concerned with the diagrams, however, provide reference to the accompanying drawings and description only and is not intended to be limiting of the invention.

In drawings,

FIG. 1 is a diagram that the ultraviolet light alignment is performed with the first ultraviolet light irradiation in the manufacture process of the PSVA liquid crystal display panel according to prior art;

FIG. 2 is a diagram that reactive monomer remained in the liquid crystal material is removed with the second ultraviolet light irradiation in the manufacture process of the PSVA liquid crystal display panel according to prior art;

FIG. 3 is a diagram that no reactive monomer remains after twice of ultraviolet light irradiations in the manufacture process of the PSVA liquid crystal display panel according to prior art;

FIG. 4 is a flowchart of the manufacture method of the PSVA liquid crystal display panel according to the present invention;

FIG. 5 is a diagram of the step 1 of the manufacture method of the PSVA liquid crystal display panel according to the present invention;

FIG. 6 is a diagram of the step 2 of the manufacture method of the PSVA liquid crystal display panel according to the present invention;

FIG. 7 is a diagram of the step 3 of the manufacture method of the PSVA liquid crystal display panel according to the present invention;

FIG. 8 is a structure diagram of the PSVA liquid crystal display panel obtained in the step 3 of the manufacture method of the PSVA liquid crystal display panel according to the present invention.

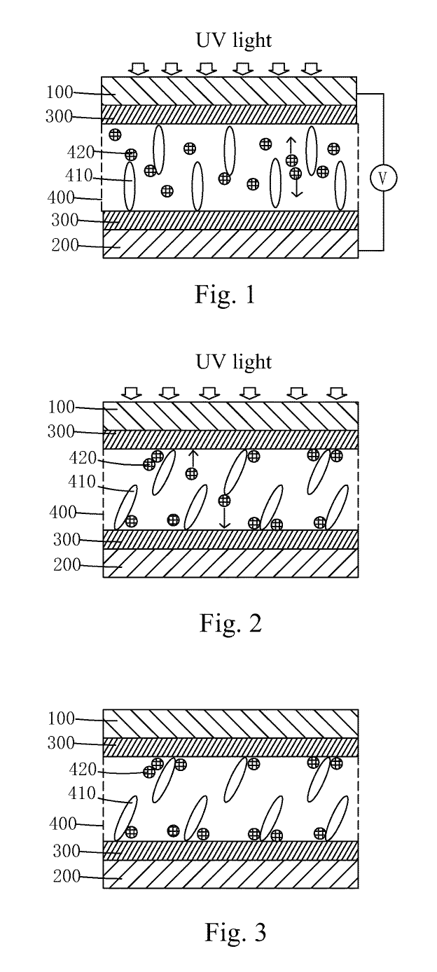

### DETAILED DESCRIPTION OF PREFERRED EMBODIMENTS

For better explaining the technical solution and the effect of the present invention, the present invention will be further described in detail with the accompanying drawings and the specific embodiments.

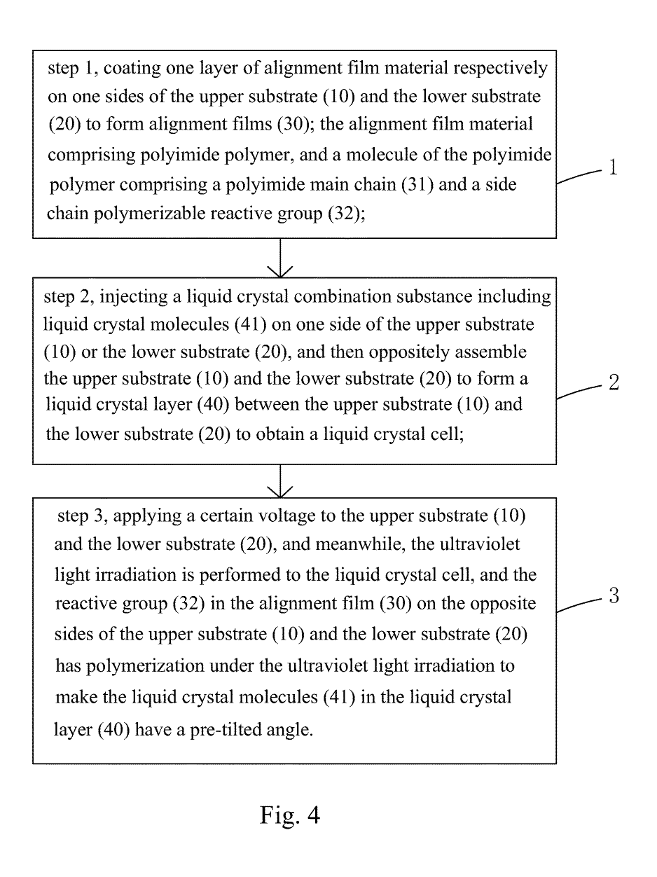

Please refer to FIG. 4. The present invention provides a manufacture method of a PSVA liquid crystal panel, comprising steps of:

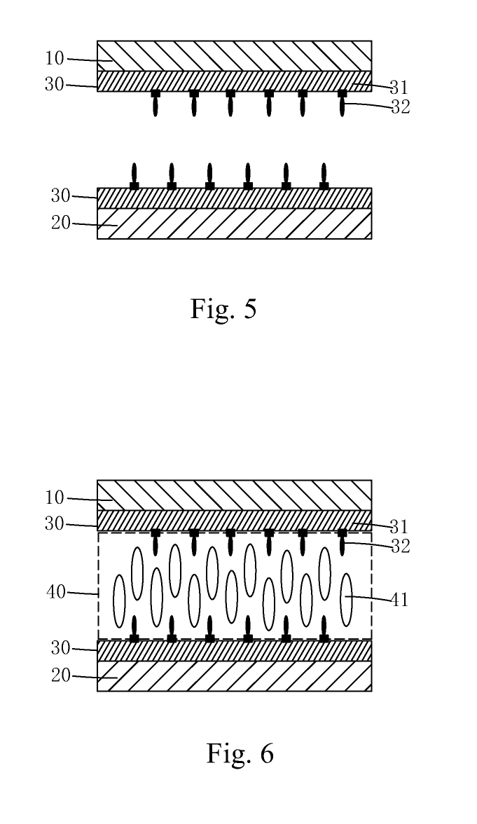

step 1, as shown in FIG. 5, providing an upper substrate 10 and a lower substrate 20, and coating one layer of alignment film material respectively on one sides of the upper substrate 10 and the lower substrate 20 to form alignment films 30; the alignment film material comprising polyimide polymer, and a molecule of the polyimide polymer comprising a polyimide main chain 31 and a side chain polymerizable reactive group 32.

Specifically, the polyimide main chain 31 in the molecule of the polyimide polymer is

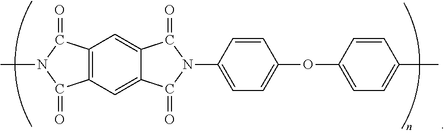

The side chain polymerizable reactive group 32 in the molecule of the polyimide polymer is a group comprising a plurality of carbon-carbon double bond, and specifically, the chemical structural formula is —X—F—B-(m)ₙ-G-Y;

wherein X is benzyl, —COO—, —O— or —CH2-;

F is —(C═C)ⱼ—, and j is 1-20;

B is diphenyl or 1,4-phenylene;

m is —COO—, —O— or —CH2-, and n is 1-10;

G is —(CH2)_{K}—, and K is 1-20;

Y is

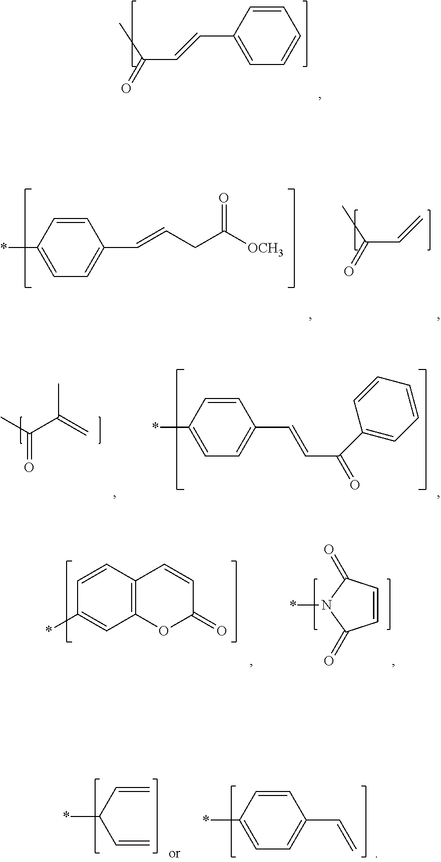

Specifically, in the step 1, first, the cleaning apparatus is employed to clean the surfaces of the upper substrate 10 and the lower substrate 20 so that they can possess well ability of coating and immersing. Then, the upper substrate 10 and the lower substrate 20 are put into the drying oven for drying, and then A layer of alignment material is uniformly coated respectively on one sides of the upper substrate 10 and the lower substrate 20 with Inkjet method, and then, the processes of Pre Bake, Post Bake are performed to cure the alignment film 30 on the upper substrate 10 and the lower substrate 20.

Specifically, the polyimide polymer is formed by connecting the reactive monomer to the main body material, in which the reactive monomer is connected to the main body material to form a side chain polymerizable reactive group 32 in the molecule of the polyimide polymer; the reactive monomer comprises photo polymerization reaction monomer and thermal polymerization reaction monomer. Specifically, the upper substrate 10 is a color film substrate, and the lower substrate 20 is a TFT array substrate.

step 2, as shown in FIG. 6, injecting a liquid crystal combination substance including liquid crystal molecules 41 on one side of the upper substrate 10 or the lower substrate 20 with the alignment film 30, and then making sides of the upper substrate 10 and the lower substrate 20 having the alignment films 30 face with each other to oppositely assemble the upper substrate 10 and the lower substrate 20 to be a cell to form a liquid crystal layer 40 between the upper substrate 10 and the lower substrate 20 to obtain a liquid crystal cell.

Specifically, in the step 2, an one drop filling (ODF) is employed to inject the liquid crystal combination substance on one side of the upper substrate 10 or the lower substrate 20. Such manufacture process can greatly save the liquid crystal material and the time of dropping and injecting the liquid crystal.

Furthermore, the side chain polymerizable reactive group 32 of the polyimide polymer in the alignment film 30 is formed with the reactive monomer, and can continue the polymerization and act the alignment function to the liquid crystal molecules 41. Thus, the liquid crystal combination substance is not mixed with any reactive monomer.

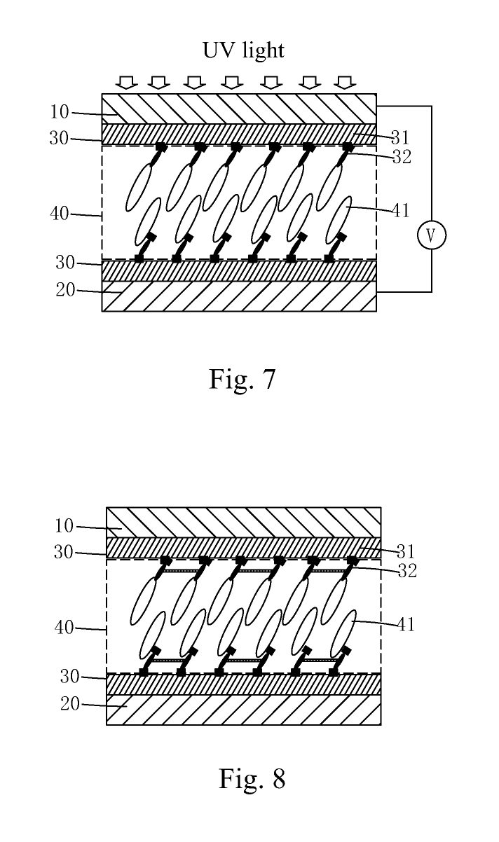

step 3, as shown in FIG. 7, applying a certain voltage to the upper substrate 10 and the lower substrate 20, wherein the liquid molecules 41 in the liquid crystal layer 40 are orientated according to a certain angle under the voltage drive, and meanwhile, the ultraviolet light irradiation is performed to the liquid crystal cell from the sides of the upper substrate 10 and the lower substrate 20 at the same time, and the reactive group 32 of the polyimide polymer side chain in the alignment film 30 on the opposite sides of the upper substrate 10 and the lower substrate 20 has polymerization under the ultraviolet light irradiation according to the direction of the liquid molecules 41 which are orientated to make the liquid crystal molecules 41 in the liquid crystal layer 40 have a pre-tilted angle to accomplish the ultraviolet light alignment process. As shown in FIG. 8, after the voltage is removed, and the ultraviolet light irradiation is stopped, the liquid crystal molecules 41 in the liquid crystal layer 40 still have a certain pre-tilted angle under the function of the polymer formed by the reactive group 32.

Specifically, in the step 3, the ultraviolet light that a wavelength is between 300 nanometer and 400 nanometer, and an irradiation intensity is between 0.08 mW/cm² and 10 mW/cm² is employed to irradiate the liquid crystal cell, and a irradiation duration is 50 second to 600 second, which is enough to make the liquid crystal molecules 41 have the pre-tilted angle, and the formed pre-tilted angle is 88° to 89°.

Specifically, in the step 3, as the wavelength of the ultraviolet light is 313 nanometer, the irradiation intensity is between 0.08 mW/cm² and 10 mW/cm².

Specifically, in the manufacture method of the PSVA liquid crystal panel according to the present invention, only one time of ultraviolet light irradiation process is required for achieving the ultraviolet light alignment. The side chain polymerizable reactive group 32 of the polyimide polymer in the alignment film 30 is formed with the reactive monomer, and can continue the polymerization and act the alignment function to the liquid crystal molecules 41. Thus, the liquid crystal layer 40 does not comprise any reactive monomer. After one time of the ultraviolet light alignment, the liquid crystal layer 40 does not comprise any free reactive monomer. The second time of ultraviolet light irradiation process is not required to eliminate the free reactive monomer from the liquid crystal layer 40. It significantly shortens the operation time of the production and raises the production capacity. Furthermore, because the reactive monomer is fixed on the alignment film 30 with connection, the non-uniform distribution of the reactive monomers does not exist. In the production manufacture process, the issue of drop Mura does not happen due to the non-uniform distribution of the reactive monomers, and the issue of broken bright spot does not happen due to the implosion of the reactive monomers, and thus, the quality of the liquid crystal panel is promoted.

In conclusion, the present invention provides a manufacture method of a PSVA liquid crystal panel. The alignment film material of forming the alignment film comprises polyimide polymer, and a molecule of the polyimide polymer comprises a polyimide main chain and a side chain polymerizable reactive group. The alignment of the liquid crystal molecules can be achieved with one time of ultraviolet irradiation that the reactive group of the polyimide polymer side chain in the alignment film has polymerization. In comparison with the manufacture method of the PSVA liquid crystal panel according to prior art, the reactive monomer, which makes the liquid crystal have pre-tilted angle by the polymerization, is employed to be the side chain group directly connected to the main body material of the alignment film material to form the reactive group on the polyimide polymer but not mixed in the liquid crystal material. No free reactive monomer exists in the liquid crystal layer. Thus, it is not required to perform the second time ultraviolet irradiation to eliminate the reactive monomers mixed in the liquid crystal layer, and meanwhile, the issues of the drop Mura, broken bright spot of the liquid crystal panel can be prevented to decrease the production cost and to raise the liquid crystal panel quality.

Above are only specific embodiments of the present invention, the scope of the present invention is not limited to this, and to any persons who are skilled in the art, change or replacement which is easily derived should be covered by the protected scope of the invention. Thus, the protected scope of the invention should go by the subject claims.

What is claimed is:

1. A manufacture method of a PSVA liquid crystal panel, comprising steps of:
step 1, providing an upper substrate and a lower substrate, and coating one layer of alignment film material respectively on one sides of the upper substrate and the lower substrate to form alignment films;
the alignment film material comprising polyimide polymer, and a molecule of the polyimide polymer comprising a polyimide main chain and a side chain polymerizable reactive group;
step 2, injecting a liquid crystal combination substance including liquid crystal molecules on one side of the upper substrate or the lower substrate with the alignment film, and then making sides of the upper substrate and the lower substrate having the alignment films face with each other to oppositely assemble the upper substrate and the lower substrate to be a cell to form a liquid crystal layer between the upper substrate and the lower substrate to obtain a liquid crystal cell;
step 3, applying a certain voltage to the upper substrate and the lower substrate, and irradiating ultraviolet light to the liquid crystal cell and the reactive group of the polyimide polymer side chain in the alignment film on the opposite sides of the upper substrate and the lower substrate having polymerization under irradiation of the ultraviolet light to make the liquid crystal molecules in the liquid crystal layer have pre-tilted angle.

2. The manufacture method of the PSVA liquid crystal panel according to claim 1, wherein in the step 3, a wavelength of the ultraviolet light irradiating the liquid crystal cell is between 300 nanometer and 400 nanometer.

3. The manufacture method of the PSVA liquid crystal panel according to claim 2, wherein in the step 3, an irradiation intensity of the ultraviolet light irradiating the liquid crystal cell is between 0.08 mW/cm² and 110 mW/cm².

4. The manufacture method of the PSVA liquid crystal panel according to claim 3, wherein in the step 3, the wavelength of the ultraviolet light irradiating the liquid crystal cell is 313 nanometer, and the irradiation intensity is between 0.08 mW/cm² and 10 mW/cm².

5. The manufacture method of the PSVA liquid crystal panel according to claim 2, wherein in the step 3, a duration of the ultraviolet light irradiating the liquid crystal cell is 50 second to 600 second.

6. The manufacture method of the PSVA liquid crystal panel according to claim 1, wherein in the step 2, an one drop filling is employed to inject the liquid crystal combination substance on one side of the upper substrate or the lower substrate.

7. The manufacture method of the PSVA liquid crystal panel according to claim 1, wherein in the step 3, the pre-tilted angle of the liquid crystal layer is 88° to 89°.

8. The manufacture method of the PSVA liquid crystal panel according to claim 1, wherein the upper substrate is a color film substrate, and the lower substrate is a TFT array substrate.

9. The manufacture method of the PSVA liquid crystal panel according to claim 1, wherein the step 1 further comprises performing a pre baking process and a high temperature baking process to form the alignment films after coating one layer of alignment film material respectively on one sides of the upper substrate and the lower substrate.

10. A manufacture method of a PSVA liquid crystal panel, comprising steps of:
step 1, providing an upper substrate and a lower substrate, and coating one layer of alignment film material respectively on one sides of the upper substrate and the lower substrate to form alignment films;
the alignment film material comprising polyimide polymer, and a molecule of the polyimide polymer comprising a polyimide main chain and a side chain polymerizable reactive group;
step 2, injecting a liquid crystal combination substance including liquid crystal molecules on one side of the upper substrate or the lower substrate with the alignment film, and then making sides of the upper substrate and the lower substrate having the alignment films face with each other to oppositely assemble the upper substrate and the lower substrate to be a cell to form a liquid crystal layer between the upper substrate and the lower substrate to obtain a liquid crystal cell;
step 3, applying a certain voltage to the upper substrate and the lower substrate, and irradiating ultraviolet light to the liquid crystal cell and the reactive group of the polyimide polymer side chain in the alignment film on the opposite sides of the upper substrate and the lower substrate having polymerization under irradiation of the ultraviolet light to make the liquid crystal molecules in the liquid crystal layer have pre-tilted angle;
wherein in the step 2, an one drop filling is employed to inject the liquid crystal combination substance on one side of the upper substrate or the lower substrate;
wherein in the step 3, the pre-tilted angle of the liquid crystal layer is 88° to 89°;
wherein the upper substrate is a color film substrate, and the lower substrate is a TFT array substrate.

11. The manufacture method of the PSVA liquid crystal panel according to claim 10, wherein in the step 3, a wavelength of the ultraviolet light irradiating the liquid crystal cell is between 300 nanometer and 400 nanometer.

12. The manufacture method of the PSVA liquid crystal panel according to claim 11, wherein in the step 3, an irradiation intensity of the ultraviolet light irradiating the liquid crystal cell is between 0.08 mW/cm² and 110 mW/cm².

13. The manufacture method of the PSVA liquid crystal panel according to claim 12, wherein in the step 3, the wavelength of the ultraviolet light irradiating the liquid crystal cell is 313 nanometer, and the irradiation intensity is between 0.08 mW/cm² and 10 mW/cm².

14. The manufacture method of the PSVA liquid crystal panel according to claim 11, wherein in the step 3, a duration of the ultraviolet light irradiating the liquid crystal cell is 50 second to 600 second.

15. The manufacture method of the PSVA liquid crystal panel according to claim 10, wherein the step 1 further comprises performing a pre baking process and a high temperature baking process to form the alignment films after coating one layer of alignment film material respectively on one sides of the upper substrate and the lower substrate.
